(19) United States
(12) Patent Application Publication
(10) Pub. No.: US 2008/0018523 A1
(43) Pub. Date: Jan. 24, 2008

(54) METHOD AND SYSTEM FOR RADAR PROCESSING

(76) Inventors: Thomas M. Kelly, Jr., Dedham, MA (US); Wilson J. Wimmer, Hudson, NH (US); Dennis Hunt, Westford, MA (US)

Correspondence Address: VALEO RAYTHEON SYSTEMS, INC.;c/o DALY, CROWLEY, MOFFORD AND DURKEE, LLP, 354A TURNPIKE STREET, SUITE 301-A, CANTON, MA, 02021-2714, US

(21) Appl. No.: 11/458,126

(22) Filed: Jul. 18, 2006

(51) Int. Cl. G01S 13/93

(52) U.S. Cl. 342/70; 342/21; 342/91; 342/192; 340/435; 340/436; 340/903; 342/195

(57) ABSTRACT

A method of radar processing includes selecting a detection threshold in accordance with a mathematical function of angle and/or scaling a radar return signal in accordance with the mathematical function of angle. Apparatus for radar processing includes a threshold selection processor adapted to select a detection threshold in accordance with a mathematical function of angle and/or a scaling value selection value selection processor, which, in combination with a scaling application processor, is adapted to scale a radar return signal in accordance with the mathematical function of angle.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

This invention relates generally to vehicle radar systems and more particularly to vehicle radar systems adapted to detect other vehicles and objects in proximity to the vehicle.

### BACKGROUND OF THE INVENTION

As is known by those in the art, radar systems have been developed for various applications associated with vehicles, such as automobiles and boats. A radar system mounted on a vehicle detects the presence of objects, including other vehicles, in proximity to the vehicle. In an automotive application, such a radar system can be used in conjunction with the braking system to aid in collision avoidance or in conjunction with the automobile cruise control system to provide intelligent speed and traffic spacing control. In a further application, the vehicle radar system provides a passive indication of obstacles to a driver of the vehicle on a display, and in particular, detects objects in a so-called blind spot of the vehicle.

In an effort to reduce the number and impact of blind spots, rear and side view mirrors of various sizes and types are typically mounted on a vehicle. While the use of mirrors helps reduce the number of blind spots on a vehicle, mirrors cannot eliminate all blind spots. Also, the view through mirrors degrades during conditions of rain, snow, or darkness.

Cameras mounted on the back and sides of a vehicle can also be effective in reducing blind spots. However, this approach is relatively expensive and at least a portion of the camera must be exposed to external elements. Also, the view through a camera degrades during severe weather (e.g. rain, show) and in darkness.

### SUMMARY OF THE INVENTION

The present invention provides a system and method for radar processing associated with a multi-beam radar system. While examples of the method and system shown below include a radar system as used on an automobile, and, in particular, a side object detection (SOD) radar, the method and system apply to any radar system.

In accordance with the present invention, a method of radar processing includes transmitting an RF signal toward an object and receiving an echo RF signal indicative of the object. The method also includes beamforming the echo RF signal to provide a beamformed signal associated with a spatial angle and processing the beamformed signal to provide a baseband signal. The method further includes converting the baseband signal to the frequency domain to provide a frequency domain signal. The method also includes selecting a threshold in accordance with the frequency domain signal and in accordance with a mathematical function relating the spatial angle to a magnitude, comparing the frequency domain signal with the threshold, and generating a detection value in response to the comparing.

In accordance with another aspect of the present invention, a method of radar processing includes transmitting an RF signal toward an object and receiving an echo RF signal indicative of the object. The method also includes beamforming the echo RF signal to provide a beamformed signal associated with a spatial angle and processing the beamformed signal to provide a baseband signal. The method further includes converting the baseband signal to the frequency domain to provide a frequency domain signal. The method also includes selecting a scaling value. The scaling value is selected in accordance with a mathematical function relating the spatial angle to a magnitude. The method also includes magnitude scaling the frequency domain signal in accordance with the scaling value. The method further includes selecting a threshold, comparing the magnitude scaled frequency domain signal with the threshold, and generating a detection value in response to the comparing.

In accordance with another aspect of the present invention, radar apparatus includes a radar transmitter adapted to transmit an RF signal toward an object and a radar receiver adapted to receive an echo RF signal indicative of the object and adapted to beamform the echo RF signal to provide a beamformed signal associated with a spatial angle. The radar apparatus also includes a baseband converter adapted to process the beamformed signal to provide a baseband signal and a frequency domain processor adapted to convert the baseband signal to the frequency domain to provide a frequency domain signal. The radar apparatus further includes a threshold selection processor adapted to select a threshold in accordance with the frequency domain signal and in accordance with a mathematical function relating the spatial angle to a magnitude, and a threshold application processor adapted to compare the frequency domain signal with the threshold and further adapted to generate a detection value in response to the comparison.

In accordance with another aspect of the present invention, radar apparatus includes a radar transmitter adapted to transmit an RF signal toward an object and a radar receiver adapted to receive an echo RF signal indicative of the object and adapted to beamform the echo RF signal to provide a beamformed signal associated with a spatial angle. The radar apparatus also includes a baseband converter adapted to process the beamformed signal to provide a baseband signal and a frequency domain processor adapted to convert the baseband signal to the frequency domain to provide a frequency domain signal. The radar apparatus further includes a scaling value selection processor adapted to select a scaling value, wherein the scaling value is selected in accordance with a mathematical function relating the spatial angle to a magnitude. The radar apparatus further includes a scaling application processor adapted to magnitude scale the frequency domain signal in accordance with the scaling value. The radar apparatus further includes a threshold selection processor adapted to select a threshold and a threshold application processor adapted to compare the magnitude scaled frequency domain signal with the threshold and further adapted to generate a detection value in response to the comparing.

### BRIEF DESCRIPTION OF THE DRAWINGS

The foregoing features of the invention, as well as the invention itself may be more fully understood from the following detailed description of the drawings, in which:

FIG. 1 is a pictorial of a vehicle on which a side object detection (SOD) radar is mounted, which is traveling on a roadway;

FIG. 2 is a block diagram showing a vehicle on which two SOD radars are mounted;

FIG. 3 is block diagram of a SOD radar;

FIG. 4 is a graph showing a relationship between return signal strength and azimuth angle (i.e., beam) for the SOD radar in the presence of an automobile in an adjacent travel lane at different relative positions to the SOD radar;

FIG. 4A is a graph showing a variety of mathematical functions;

FIG. 5 is a graph showing a plurality of measured receive beams generated by a SOD radar system in units of beam detection sensitivity using a calibrated target moving past the radar system;

FIG. 6 a graph showing another plurality of measured receive beams generated by a SOD radar system in units of beam detection sensitivity using a calibrated target moving past the radar system;

FIGS. 6A and 6B are graphs representative of the beams of FIG. 6;

FIG. 7 is a flow chart showing a method used to process signals associated with each one of a plurality of receive beams, for example, the beams of FIG. 6;

FIG. 7A is a flow chart showing further details of a portion of the method of FIG. 7;

FIG. 8 is a flow chart of another method used to process signals associated with each one of a plurality of receive beams, for example, the beams of FIG. 6;

FIGS. 8A is a flow chart showing further details of a portion of the method of FIG. 8;

FIG. 9 is a block diagram showing further details of the SOD radar of FIG. 3, having a threshold selection processor;

FIG. 9A is a block diagram showing further details of the threshold selection processor of FIG. 9;

FIG. 10 is a block diagram showing further details of the another embodiment of the SOD radar of FIG. 3, having a threshold selection processor; and

FIG. 10A is a block diagram showing further details of the threshold selection processor of FIG. 10.

### DETAILED DESCRIPTION OF THE INVENTION

Before describing the present invention, some introductory concepts and terminology are explained. As used herein, the term “received RF signal” is used to describe a radio frequency (RF) signal received by a receiving radar antenna. As used herein, the term “transmitted RF signal” is used to describe an RF signal transmitted through a transmitting radar antenna. The transmit and receive antennas may be the same physical antenna (i.e. one antenna is used for both transmit and receive paths of the radar system) or may be separate antennae. As used herein, the term “echo RF signal” is used to describe an RF signal resulting from a transmitted RF signal impinging upon an object and reflecting and/or scattering from the object. In view of the above definitions, it should be appreciated that a received RF signal may or may not include an echo RF signal.

As used herein, the term “composite signal” is used to describe a signal with contributions from at least one of a received RF signal or a noise signal.

As used herein, the term “chirp signal” (or more simply “chirp”) is used to describe a signal having a frequency that varies with time during a time window, and which has a start frequency and an end frequency associated with each chirp. A chirp can be a linear chirp, for which the frequency varies in a substantially linear fashion between the start and end frequencies. A chirp can also be a non-linear chirp, in which the frequency varies in a substantially non-linear fashion between the start and end frequencies. A chirp signal can be transmitted through a variety of media, for example, through the air as a transmitted RF chirp signal, or through some other type of transmission media (e.g. a coaxial cable).

As used herein, the term “controller area network” or “CAN” is used to describe a control bus and associated control processor commonly disposed in automobiles. The CAN bus is typically coupled to a variety of vehicle systems (e.g. air bag, brakes, etc.) A CAN processor is coupled to vehicle systems through the CAN bus which allows the CAN processor to control a variety of automobile functions, for example, anti-lock brake functions. The CAN network may be implemented as a wired or a wireless network.

Reference is made herein below to certain processing operations, which are accomplished using fast Fourier transforms (FFTs). It should, of course, be appreciated that other techniques can also be used to convert time domain signals to the frequency domain. These techniques include, but are not limited to, discrete Fourier transforms (DFTs).

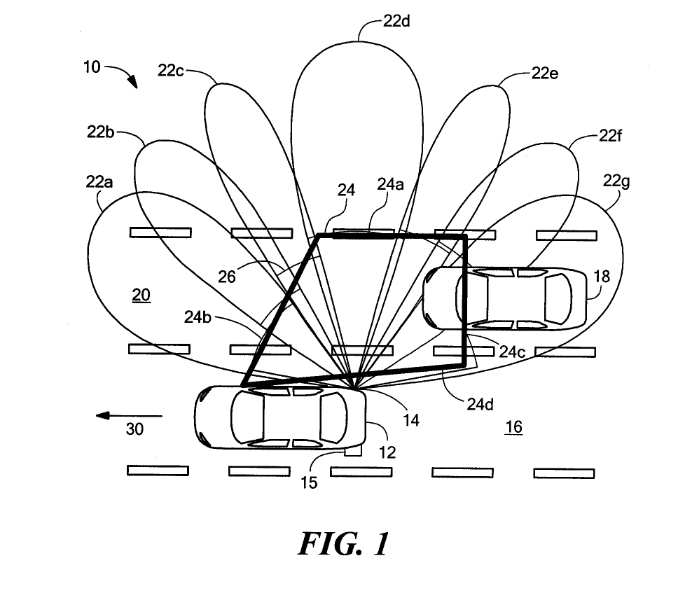

Referring to FIG. 1, a first vehicle 12 traveling in a first traffic lane 16 of a road includes a side object detection (SOD) radar 14. The SOD radar 14 is disposed on a side portion of the vehicle 12 and in particular, the SOD radar 14 is disposed on a right rear quarter of the vehicle 14. The vehicle 12 also includes a second SOD radar 15 disposed on a side portion of a left rear quarter of the vehicle 12. The SOD radars 14, 15 may be coupled to the vehicle 12 in a variety of ways. In some embodiments, the SOD radars may be coupled to the vehicle 12 as described in U.S. Pat. No. 6,489,927, issued Dec. 3, 2002, which is incorporated herein by reference in its entirety. A second vehicle 18 travels in a second traffic lane 20 adjacent to the first traffic lane 16. The first and second vehicles 12, 18 are both traveling in a direction according to an arrow 30 and in the respective first and second traffic lanes 16, 20.

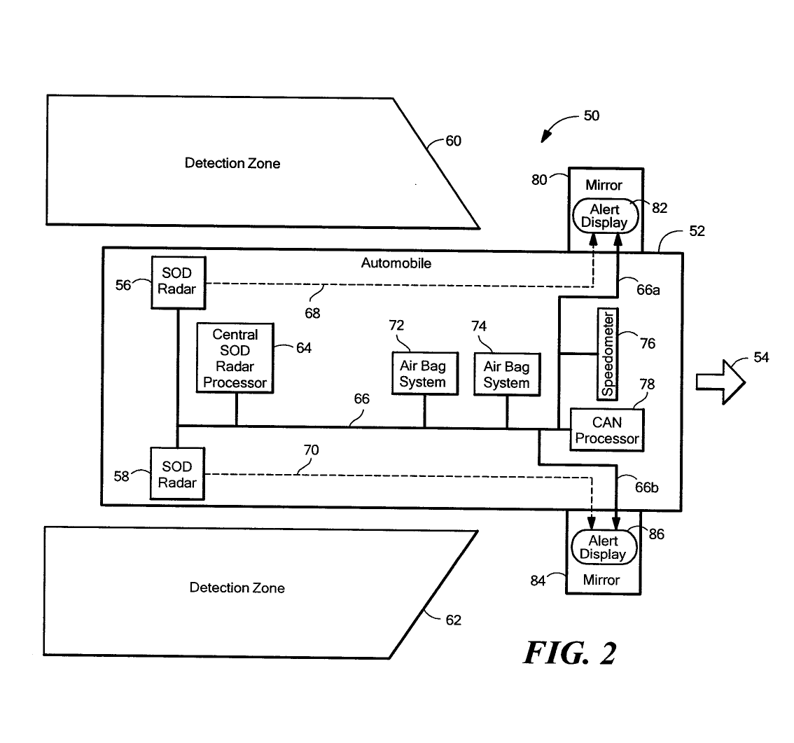

The second vehicle 18 may be traveling slower than, faster than, or at the same speed as the first vehicle 12. With the relative position of the vehicles 12, 18 shown in FIG. 1, the second vehicle 18 is positioned in a “blind spot” of the first vehicle 12. The blind spot is an area located on a side of the first vehicle 12 whereby an operator of the first vehicle 12 is unable to see the second vehicle 18 either through side-view mirrors 80, 84 (see FIG. 2) or a rear-view mirror (not shown) of the first vehicle 12.

The SOD radar 14 generates multiple receive beams (e.g., a receive beam 22a, a receive beam 22b, a receive beam 22c, a receive beam 22d, a receive beam 22e, a receive beam 22f and a receive beam 22g) and an associated detection zone 24 having edges 24a-24d. The edges 24a-24c of the detection zone 24 are formed by the SOD radar 14 by way of maximum detection ranges associated with each one of the receive beams 22a-22g, for example, the maximum detection range 26 associated with the receive beam 22c. Each of the receive beams 22a-22g may also have a minimum detection range (not shown), forming the edge 24d of the detection zone 24 closest to the first vehicle. It should be appreciated that in this exemplary embodiment the detection zone 24 is selected having a size and shape such that at least a portion of the detection zone lies over (or “covers”) a blind spot of the vehicle.

In one particular embodiment, the SOD radar 14 is a frequency modulated continuous wave (FMCW) radar, which transmits continuous wave chirp RF signals, and which processes received RF signals accordingly. In some embodiments, the SOD radar 14 may be of a type described, for example, in U.S. Pat. No. 6,577,269, issued Jun. 10, 2003; U.S. Pat. No. 6,683,557, issued Jan. 27, 2004; U.S. Pat. No. 6,642,908, issued Nov. 4, 2003; U.S. Pat. No. 6,501,415, issued Dec. 31, 2002; and U.S. Pat. No. 6,492,949, issued Dec. 10, 2002, which are all incorporated herein by reference in their entirety.

In operation, the SOD radar 14 transmits an RF signal. At least portions of the transmitted RF signal impinge upon and are reflected from the second vehicle 18. The reflected signals (also referred to as “echo” RF signals) are received in one or more of the receive beams 22a-22g. Other ones of the radar beams 22a-22g, which do not receive the echo RF signal from the second vehicle 18, receive and/or generate other RF signals, for example, noise signals.

In some embodiments, the SOD radar 14 can transmit RF energy in a single broad transmit beam (not shown). In other embodiments, the SOD radar 14 may transmit RF energy in multiple transmit beams (not shown), for example, in seven transmit beams associated with the receive beams 22a-22g. It should be appreciated, of course, that the principles described herein apply regardless of the particular number of receive beams.

The SOD radar 14 processes the received RF signals associated with each one of the receive beams 22a-22g in sequence, in parallel, or in any other time sequence. The SOD radar 14 detects echo RF signals associated with the second vehicle 18 when any portion of the second vehicle 18 is within the detection zone 24. Therefore, the SOD radar 14 is adapted to detect the second vehicle 18 when at least a portion of the second vehicle is in or near the blind spot of the first vehicle 12.

To this end, signal processing provided by the SOD radar 14, in some embodiments, can be of a type described, for example, in U.S. Pat. No. 6,577,269, issued Jun. 10, 2003, U.S. Pat. No. 6,683,557, issued Jan. 27, 2004, U.S. patent application Ser. No. 11/323,960, filed Dec. 30, 2005, entitled “Generating Event Signals in a Radar System,” having inventors Dennis Hunt and Walter Gordon Woodington, and having attorney docket number VRS-019PUS, U.S. patent application Ser. No. 11/322,684, filed Dec. 30, 2005, entitled “System and Method for Generating a Radar Detection Threshold,” having inventors Steven P. Lohmeier and Wilson J. Wimmer, and having attorney docket number VRS-014PUS, U.S. patent application Ser. No. 11/324,073, filed Dec. 30, 2005, entitled “System and Method for Verifying a Radar Detection,” having inventors Steven P. Lohmeier and Yong Liu, and having attorney docket number VRS-015PUS, and U.S. patent application Ser. No. 11/322,869, filed Dec. 30, 2005, entitled “Method And System For Generating A Target Alert,” having inventors Steven P. Lohmeier, Wilson J. Wimmer, and Walter Gordon Woodington, and having attorney docket number VRS-016PUS. Each of these patents and patent applications is incorporated herein by reference in its entirety. Further processing of the composite signal by the SOD radar 14 is described more fully below.

Referring now to FIG. 2, an exemplary vehicle radar system 50 is associated with an automobile 52 generally traveling in a direction indicated by the arrow identified by reference numeral 54. It should be appreciated, however, that the system 50 does not include all of the mechanical and electrical aspects of the automobile 52. The system 50 includes one or more SOD radars 56, 58. Each one of the SOD radars 56, 58 can be the same as or similar to the SOD radar 14 of FIG. 1. Accordingly, the SOD radar 56 forms a detection zone 60 and the SOC radar 58 forms a detection zone 62.

As described above, the SOD radars 56, 58 can be coupled to the vehicle 52 in a variety of ways. In some embodiments, the SOD radars can be coupled to the vehicle 52 as described in U.S. Pat. No. 6,489,927, issued Dec. 3, 2002, which is incorporated herein by reference it its entirety.

Each one of the SOD radars 56, 58 can be coupled to a central SOD processor 64 via a Controller Area Network (CAN) bus 66. Other automobile systems can also be coupled to the CAN bus 66, for example, an air bag system 72, a braking system 74, a speedometer 76, and a CAN processor 78.

The system 50 includes two side view mirrors 80, 84, each having an alert display 82, 86, respectively, viewable therein. Each one of the alert displays 82, 86 is adapted to provide a visual alert to an operator of the vehicle 52, indicative of the presence of another automobile or other object in a blind spot of the vehicle 52.

Upon detection of an object (e.g., another vehicle) in the detection zone 24, the SOD radar 56 sends an alert signal indicating the presence of an object to either or both of the alert displays 82, 84 through the CAN bus 66. In response to receiving the alert signal, the displays 82, 84 provide an indicator (e.g., a visual, audio, or mechanical indicator), which indicates the presence of an object. Similarly, upon detection of an object in the detection zone 62, the SOD radar 58 sends an alert signal indicating the presence of another vehicle to one or both of alert displays 82, 86 through the CAN bus 66. However, in an alternate embodiment, the SOD radar 56 can communicate the alert signal to the alert display 82 through a human/machine interface (HMI) bus 68. Similarly, the SOD radar 58 can communicate an alert signal to the other alert display 86 through another human/machine interface (HMI) bus 70.

In some embodiments, the central processor 64 can combine or “fuse” data associated with each one of the SOD radars 56, 58, in order to provide fused detections of other automobiles present within the detections zones 60, 62, resulting is further display information in the alert displays 82, 86. Alternatively, the data from each SOD radar 56, 58 can be shared among all SOD radars 56, 58 and each SOD radar 56, 58 can combine (or fuse) all data provided thereto.

While two SOD radars 56, 58 are shown, the system 50 can include any number of SOD radars, including only one SOD radar. While the alert displays 82, 86 are shown to be associated with side view mirrors, the alert displays can be provided in a variety of ways. For example, in other embodiments, the alert displays can be associated with a central rear view mirror. In other embodiments, the alert displays are audible alert displays (e.g. speakers) disposed inside (or at least audible inside) the portion of the vehicle in which passengers sit.

While the CAN bus 66 is shown and described, it will be appreciated that the SOD radars 56, 58 can couple through any of a variety of other busses within the vehicle 52, including, but not limited to, an Ethernet bus, and a custom bus.

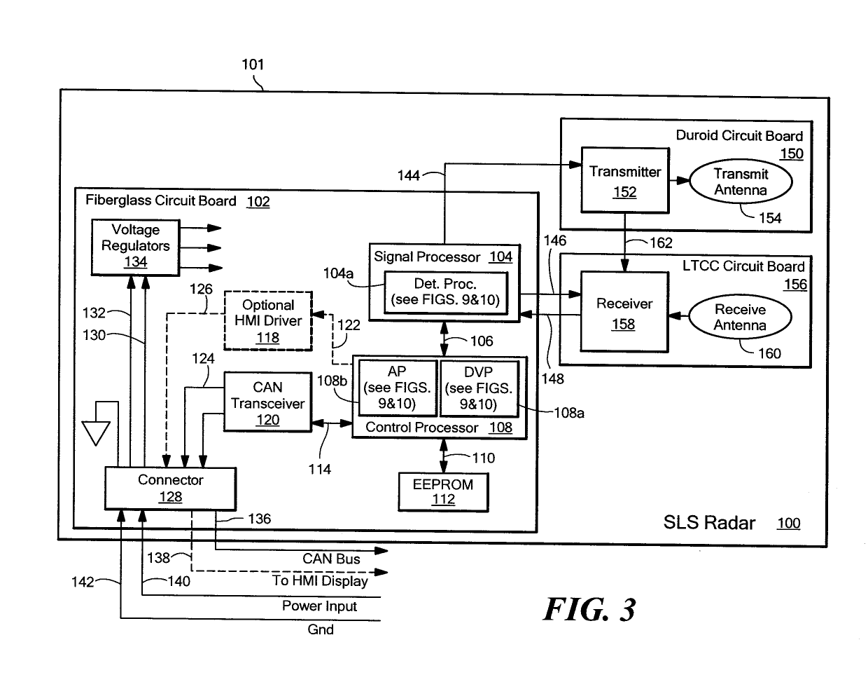

Referring now to FIG. 3, an SOD radar 100 includes a housing 101, in which a fiberglass circuit board 102, a duroid® circuit board 150, and a low temperature co-fired ceramic (LTCC) circuit board 156 reside. The SOD radar 100 can be the same as or similar to the SOD radars 14, 15, of FIG. 1 and 56, 58 of FIG. 2.

The fiberglass circuit board 102 has disposed thereon a signal processor 104 coupled to a control processor 108. In general, the signal processor 104 is adapted to perform signal processing functions, for example, fast Fourier transforms. The signal processor can include a detection processor 104a adapted to detect targets in the detection zone (e.g., detection zone 24, FIG. 1) of the SOD radar 100.

The control processor 108 is adapted to perform other digital functions, for example, to identify conditions under which an operator of a vehicle on which the SOD radar 100 is mounted should be alerted to the presence of another object such as a vehicle in a blind spot. To this end, the control processor 108 includes a detection verification processor 108a and an alert processor 108b, each of which are descried more fully below.

While the detection processor 104a, the detection verification processor 108a, and the alert processor 108b are shown to be partitioned among the signal processor 104 and control processor 108 in a particular way, any partitioning of the functions is possible.

The control processor 108 is coupled to an electrically erasable read-only memory (EEPROM) 112 adapted to retain a variety of values, for example, threshold values described more fully below. Other read-only memories associated with processor program memory are not shown for clarity.

The control processor 108 can also be coupled to a CAN transceiver 120, which is adapted to communicate, via a connector 128, on a CAN bus 136. The CAN bus 136 can be the same as or similar to the CAN bus 66 of FIG. 2.

The control processor 108 can also be coupled to an optional human/machine interface (HMI) driver 118, which can communicate via the connector 128 to an HMI bus 138. The HMI bus 138 can be the same as or similar to the HMI busses 68, 70 of FIG. 2. The HMI bus 138 can include any form of communication media and communication format, including, but not limited to, a fiber-optic media with an Ethernet format, and a wire media with a two-state format.

The fiberglass circuit board 102 receives a power signal 140 and a ground signal 142. In a U.S. automobile, the power signal 140 would typically be provided as a 12 Volt DC signal (relative to the ground signal 142). The system may of course be adapted to use other voltage levels (e.g. voltage levels used in European automobiles). Via the connector 128, the power and ground signals 140, 142, respectively, can be coupled to one or more voltage regulators 134 (only voltage regulator one being shown in FIG. 3 for clarity), which can provide one or more respective regulated voltages to the SOD radar 100.

The SOD radar 100 also includes the duroid® circuit board 150, on which is disposed radar transmitter 152 and a transmit antenna 154, which is coupled to the transmitter 154. The transmitter 152 is coupled to the signal processor 104 and the antenna 154 is coupled to the transmitter 152.

The SOD radar 100 also includes the LTCC circuit board 156 on which is disposed a radar receiver 158 and a receive antenna 160. The receiver 158 is coupled to the signal processor 104 and to the receive antenna 160. The receiver 158 can also be coupled to the transmitter 152, providing one or more RF signals 162 described below. The radar transmitter 152 and the radar receiver 158 receive regulated voltages from the voltage regulator 134.

In some embodiments, the transmit antenna 154 and the receive antenna 160 can be of a type described, for example, in U.S. Pat. No. 6,642,908, issued Nov. 4, 2003, U.S. Pat. No. 6,492,949, issued Dec. 10, 2002, U.S. patent application Ser. No. 10/293,880, filed Nov. 13, 2002, and U.S. patent application Ser. No. 10/619,020, filed Jul. 14, 2003. Each of these patents is incorporated herein by reference in its entirety.

In operation, the signal processor 104 generates one or more ramp signals 144 (also referred to as chirp control signals), each having a respective start voltage and a respective end voltage. The ramp signals are fed to the transmitter 152. In response to the ramp signals 144, the transmitter 152 generates RF chirp signals having waveform characteristics controlled by the ramp signals. The RF signals are provided from the transmitter to the transmit antenna 154, where the signal is emitted (or radiated) as RF chirp signals.

The transmit antenna 154 can be configured such that the RF chirp signals are transmitted in a single transmit beam. Alternatively, the transmit antenna can be configured such that the RF chirp signal is emitted in more than one transmit beam. In either arrangement, the transmit antenna 154 transmits the RF chirp signal in an area generally encompassing the extent of a desired detection zone, for example, the detection zone 60 of FIG. 2.

The receive antenna 160 can form more than one receive beam, for example, seven receive beams 22a-22g as shown in FIG. 1. In other embodiments, 5, 6, 8, 9, 10 or 11 beams may be used. In still other embodiments, any number of beams fewer than 7 beams or more than 7 beams can be used. Regardless of the particular number of beams, each of the receive beams, or electronics associated therewith, receives composite signals, which include at least one of received RF signals or noise signals. Signals received by the receive beams are coupled from the antenna to the radar receiver 158. The radar receiver 158 performs a variety of functions, including, but not limited to, amplification, down converting received RF signals to provide a baseband signal, and analog-to-digital (A/D) conversion of the baseband signal, resulting in a converted signal 148.

It should be appreciated that, for the SOD FMCW chirp radar system 100, the converted signal 148 has a frequency content, wherein different frequencies of peaks therein correspond to detected objects at different ranges. The above-described amplification of the receiver 158 can be a time-varying amplification, controlled, for example, by a control signal 146 provided by the signal processor 104.

The signal processor 104 analyzes the converted signals 148 to identify an object in the above-described detection zone. To this end, in one particular embodiment, the signal processor 104 performs a frequency domain conversion of the converted signals 148. In one exemplary embodiment, this is accomplished by performing an FFT (fast Fourier transform) in conjunction with each one of the receive beams.

Some objects detected in the converted signal 148 by the signal processor 104 may correspond to objects for which an operator of a vehicle has little concern and need not be alerted. For example, an operator of a vehicle may not need to be alerted as the existence of a stationary guardrail along a roadside. Thus, further criteria can be used to identify when an alert signal should be generated and sent to the operator.

The control processor 108 receives detections 106 from the signal processor 104. The control processor 108 can use the further criteria to control generation of an alert signal 114. Upon determination by the control processor 108, the alert signal 114 can be generated, which is indicative not only of an object in the detection zone, but also is indicative of an object having predetermined characteristics being in the detection zone, for example, a moving object. Alternatively, the control processor 104 can use criteria to determine that an alert signal should not be generated.

The alert signal 114 can be communicated on the CAN bus 136 by the CAN transceiver 120. In other embodiments, an alert signal 122 can be communicated on the HMI bus 138 by the optional HMI driver 118.

The fiberglass circuit board 102, the duroid® circuit board 150, and the LTCC circuit board 156 are comprised of materials having known characteristics (including but not limited to insertion loss characteristics) for signals within particular frequency ranges. It is known, for example, that fiberglass circuit boards have acceptable signal carrying performance at signal frequencies up to a few hundred MHz. LTCC circuit boards and duroid® circuit boards are know to have acceptable signal carrying performance at much higher frequencies, however, the cost of LTCC and duroid® boards is higher than the cost of fiberglass circuit boards. Thus, the lower frequency functions of the SOD radar 100 are disposed on the fiberglass circuit board 102, while the functions having frequencies in the range of frequencies are disposed on the LTCC and on the duroid® circuit boards 150, 156, respectively.

While three circuit boards 102, 150, 156 are shown, the SOD radar 100 can be provided on more than three or fewer than three circuit boards. Also, the three circuit boards 102, 150, 156 can be comprised of materials other than those described herein.

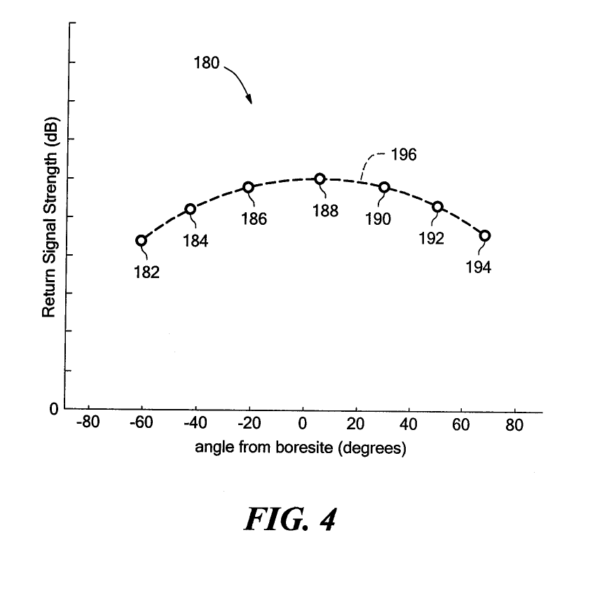

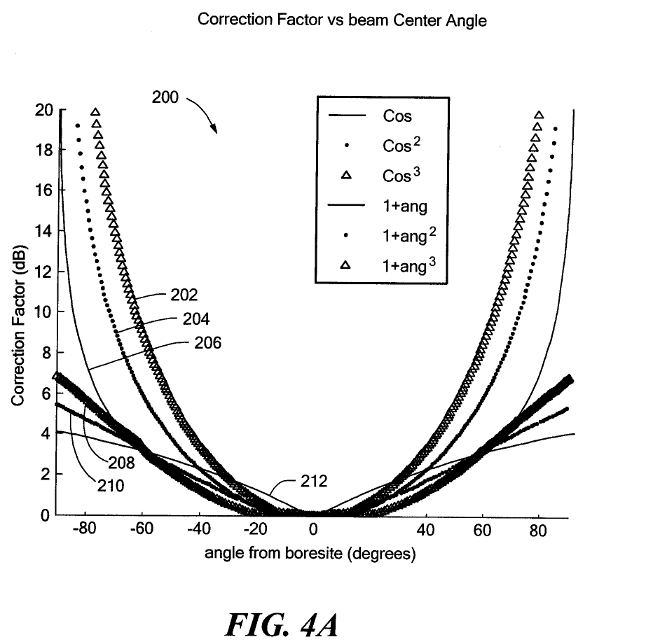

Referring now to FIG. 4, a graph 180 has a horizontal axis in units of angle from boresite, in degrees. As used herein, the term “boresite” refers to a direction relative to a SOD radar, wherein the direction is substantially perpendicular to the direction of travel 30 of the automobile 12 in FIG. 1 upon which the SOD radar 14 is mounted. The graph 200 has a vertical axis in decibel units associated with a return signal strength of radar signals (i.e., echo signals), received by the SOD radar 14 of FIG. 1, when in the presence of the automobile 18, traveling in the adjacent travel lane 20.

Referring also to FIG. 1, the point 182 of FIG. 4 is indicative a return signal strength of an echo signal received in the receive beam 22g when the automobile 18 is at a position within the beam 22g. The point 184 is indicative a return signal strength of an echo signal received in the receive beam 22f when the automobile 18 is at a position within the beam 22f. The point 186 is indicative a return signal strength of an echo signal received in the receive beam 22e when the automobile 18 is at a position within the beam 22e. The point 188 is indicative a return signal strength of an echo signal received in the receive beam 22d when the automobile 18 is at a position within the beam 22d. The point 190 is indicative a return signal strength of an echo signal received in the receive beam 22c when the automobile 18 is at a position within the beam 22c. The point 192 is indicative a return signal strength of an echo signal received in the receive beam 22b when the automobile 18 is at a position within the beam 22b. The point 194 is indicative a return signal strength of an echo signal received in the receive beam 22a when the automobile 18 is at a position within the beam 22a.

It can be appreciated that the points 182-194 are associated with a function 196, which tends to have a lower value when the automobile 18 is in front of or behind the automobile 12 (FIG. 1). When the automobile 18 is to the side of the automobile 12, i.e., within the beam 22d, the function 196 has a higher value. Thus, there is a function 196, which relates the received signal strength to an angle. The above effect is to be expected for two reasons. First, the automobile 18 is closer to the SOD radar 14 when the automobile 18 to the side of the automobile 12 than is it when the automobile 18 is in front of or behind the automobile 12. Second, the automobile 18 is generally a better radar reflector (i.e., has a larger radar cross section) when it is to the side of the automobile 12 than it does when it is in front of or behind the automobile 12.

The function 196 can be accounted for when selecting thresholds in an object detection process, which is used to determine whether the automobile 18 is present in the vicinity of the automobile 12. The object detection process and associated threshold are described more fully below.

Referring now to FIG. 4A, a graph 200 has a horizontal axis in units of angle from boresite, in degrees. The angle from boresite is described above. The graph 200 has a vertical axis in decibel units associated with a correction factor (or correction value), which is described more fully below.

A curve 202 is representative of a cosine cubed (cos³) relationship between the angle from boresite and the correction factor. A curve 204 is representative of a cosine squared (cos²) relationship between the angle from boresite and the correction factor. A curve 206 is representative of a cosine (cos) relationship between the angle from boresite and the correction factor. A curve 208 is representative of a one plus angle cubed (1+ang³) relationship between the angle from boresite and the correction factor. A curve 210 is representative of a one plus angle squared (1+ang²) relationship between the angle from boresite and the correction factor. A curve 212 is representative of a one plus angle (1+ang) relationship between the angle from boresite and the correction factor.

It can be seen that each one of the functions 202-212 tends to curve in an opposite direction from the function 196 of FIG. 4. Therefore, if applied to the beams represented by the points 182-194 of FIG. 4, the function 196 can be made to be more flat.

In one particular arrangement, a function such as one of the functions 202-212, which are functions of angle from boresite, can be used to adjust thresholds used in conjunction with receive beams represented by the points 182-194 of FIG. 4. With this arrangement, each one of the beams 22a-22g of FIG. 1 represented by points 182-194 of FIG. 4 will tend to have approximately the same detection characteristics, e.g., probability of detection. In another particular arrangement, a function such as one of the functions 202-212, can be used to scale the receive beams represented by the points 182-194 of FIG. 4. Similarly, with this arrangement, each one of the beams 22a-22g of FIG. 1 represented by points 182-194 of FIG. 4 will tend to have approximately the same detection characteristics.

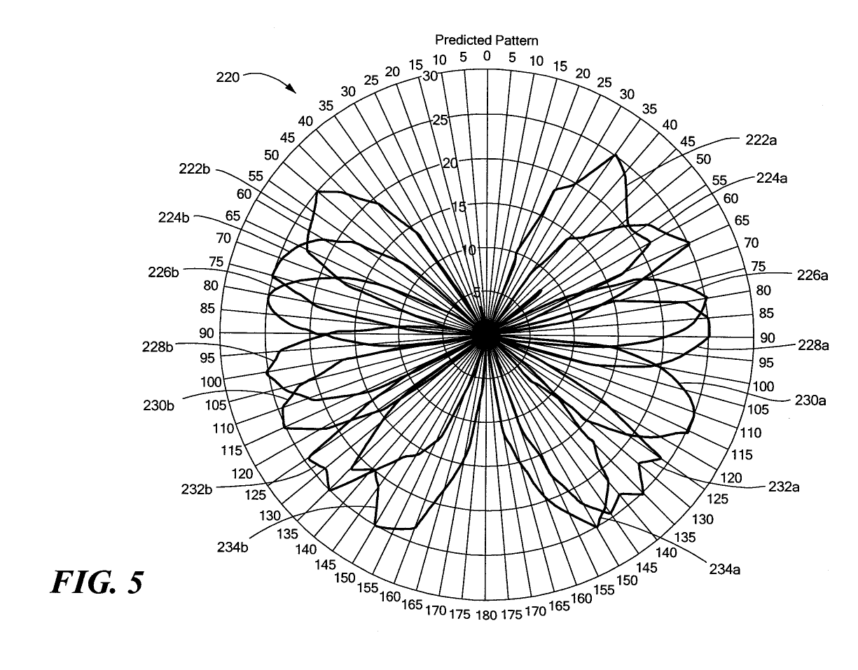

Referring now to FIG. 5, a graph 220, which is in polar coordinates, has circular axes in units of degrees and radial axes in units of power in decibels. It will be recognized that curves 222a-234a and 222b-234b are indicative of simulated beampatterns of receive beams of the SOD radar 14 of FIG. 1. The curves 222b-234b are generally symmetrical with the curves 222a-234a.

In order to generate actual beampatterns similar to the simulated beampatterns 222a-234a and 222b-234b, a calibration of the SOD radar can be performed, wherein a known radar calibration target, having a known and constant radar cross section, is moved along an arc having equal distance from the SOD radar. Any variation in detection sensitivity of the various beams is adjusted (or pre-calibrated) resulting in each one of the beampatterns 222a-234a and 222b-234b having generally equal magnitude, for example twenty-five dB.

The simulated beampatterns 222a-234a and 222b-234b are plotted in units of respective beam sensitivity minus a respective detection threshold. Therefore, each one of the beampatterns 222a-234a and 222b-234b is representative of a detection sensitivity of each one of the receive beams, which are pre-calibrated to be generally equal.

The beampatterns 222a-234a, 222b-234b are rotated slightly from the boresite direction (at ninety degrees). This is merely an artifact of the simulation, and is not intended to represent a real system. However, the rotation can be present in a real system where the SOD radar is mounted at such an angle relative to the direction of travel.

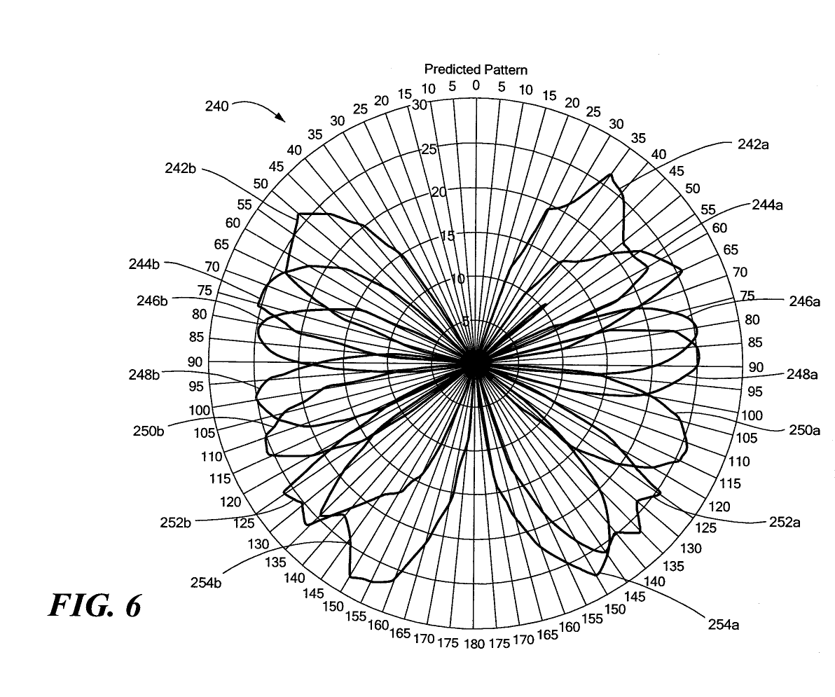

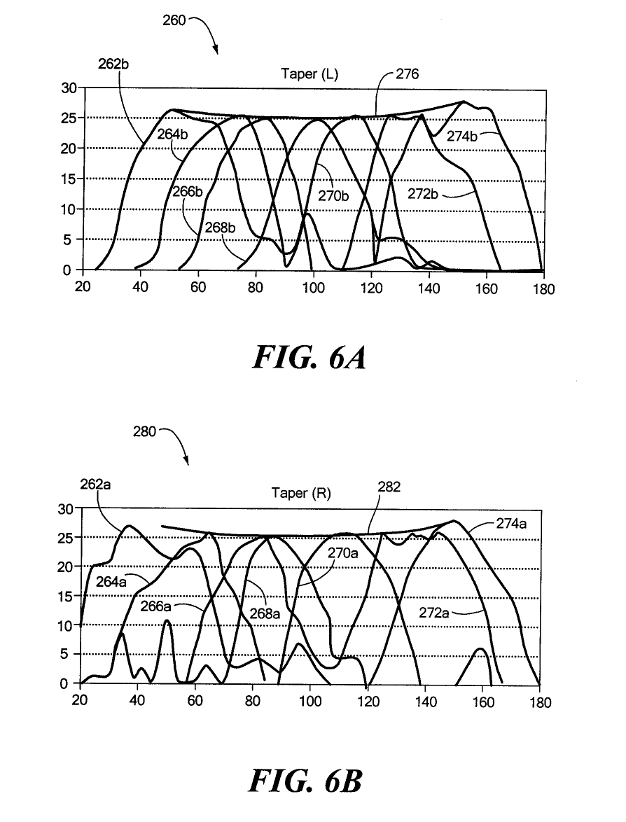

Referring now to FIG. 6, a graph 240, which is in polar coordinates, has circular axes in units of degrees and radial axes in units of power in decibels. It will be recognized that curves 242a-254a and 242b-254b are indicative of simulated beampatterns of receive beams of the SOD radar 14 of FIG. 1. The curves 242b-254b are generally symmetrical with the curves 242a-254a.

In order to achieve actual beampatterns similar to the simulated beampatterns 242a-254a and 242b-254b, the pre-calibration discussed above in conjunction with FIG. 5 can be applied to the SOD radar. Also, a mathematical function, for example, one of the mathematical functions of FIG. 4A, can be applied to achieve the simulated beampatterns 242a-254a and 242b-254b. Application of the mathematical function to the beampatterns 242a-254a and 242b-254b results in some of the beampatterns 242a-254a and 242b-254b having higher detection sensitivity than others. This can be seen since some of the beampatterns have peaks that exceed twenty-five dB.

A peak that exceed twenty-five dB represents a beam signal power to threshold difference of greater than twenty-five dB, and therefore, a higher detection sensitivity. As will become apparent from discussion below, the higher detection sensitivity can be achieved in at least two ways in accordance with a mathematical function of azimuth angle about the SOD radar. For example, in one way, a detection threshold associated with a beam can be adjusted according to the mathematical function of angle. For another example, in another way, a received signal associated with a beam can be scaled according to the mathematical function of angle. Both of these ways can achieve a detection sensitivity that is adjusted according to azimuth angle about a vehicle upon which the SOD radar is mounted.

As described above, another vehicle traveling in an adjacent travel lane to a vehicle upon which the SOD radar is mounted tends to return a smaller echo signal from the SOD radar when it is in front of or behind the vehicle upon which the SOD radar is mounted, and a stronger signal when it is beside the vehicle upon which the SOD radar is mounted. Factors influencing this azimuth variation are discussed above in conjunction with FIG. 4. Therefore, a mathematical function of angle, for example, one of the mathematical functions of FIG. 4A, can be applied in the SOD radar to make the beams directed fore and aft of the SOD radar more sensitive (i.e., have a higher detection sensitivity) than beams 228a, 228b pointed to the side of the SOD radar.

The beampatterns 242a-254a, 242b-254b a rotated slightly from the boresite direction (at ninety degrees). This is merely an artifact of the measurement, and is not intended to represent a real system. However, as described above, the rotation can be present in a real system where the SOD radar is mounted at such an angle relative to the direction of travel.

Referring now to FIGS. 6A and 6B, graphs 260, 280 show simulated beampatterns in rectangular coordinates. Each graph 260, 280 has a horizontal axis in units of angle in degrees relative to a SOD radar, wherein ninety degrees is indicative of a direction (i.e., a boresite direction) perpendicular to a direction of travel 30 (FIG. 1) of a vehicle 12 upon which a SOD radar 14 is mounted. Curves 262a-274a are indicative of beampatterns comparable to the beampatterns 242a-254a of FIG. 6. Curves 262b-274b are indicative of beampatterns comparable to the beampatterns 242b-254b of FIG. 6.

A curve 282 is drawn coupling the peaks of the beampatterns 262a-274a and a comparable curve 276 is drawn coupling the beampatterns 262b-274b. The curves 276, 282 can be the same as or similar to curves associated with one of the mathematical functions of FIG. 4A.

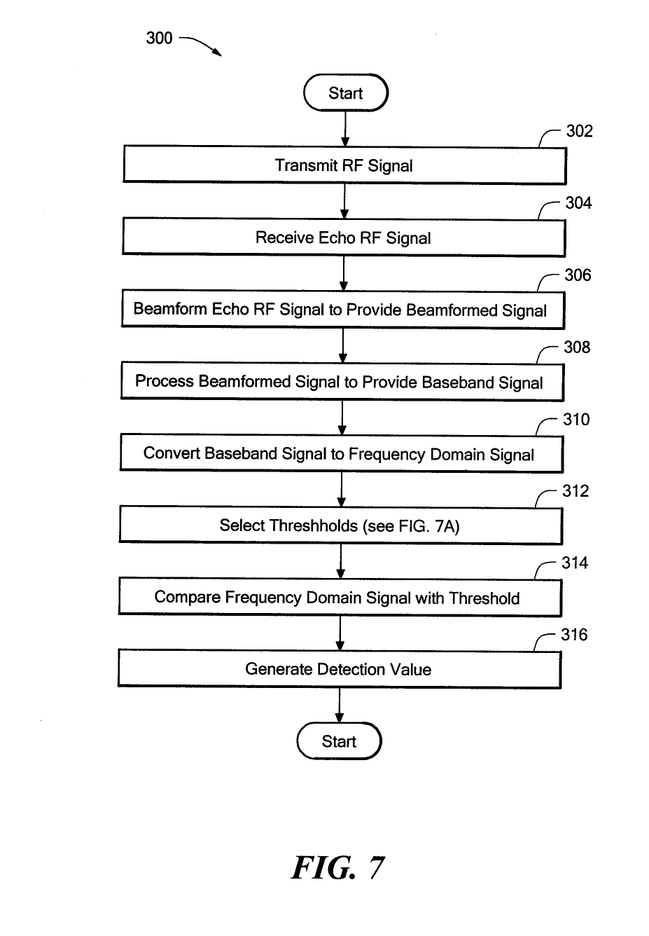

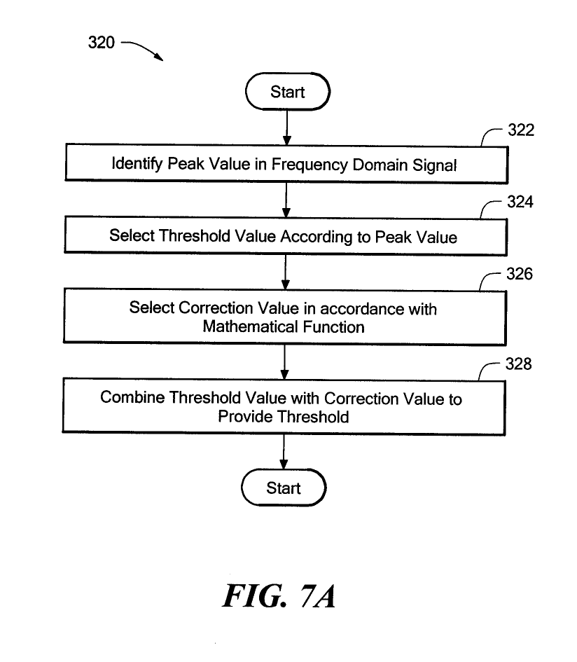

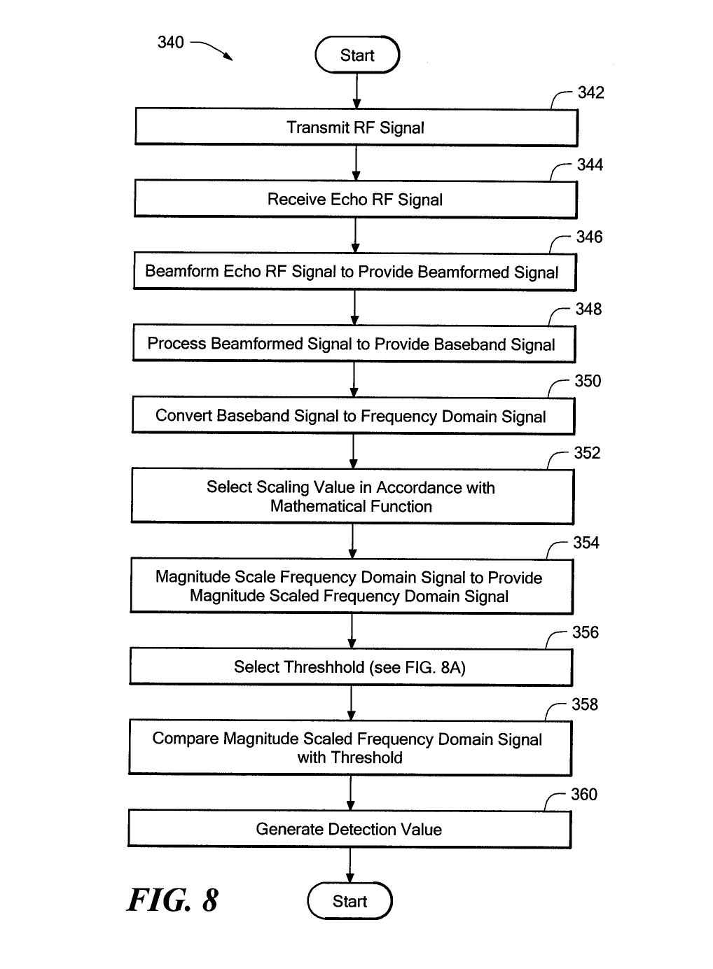

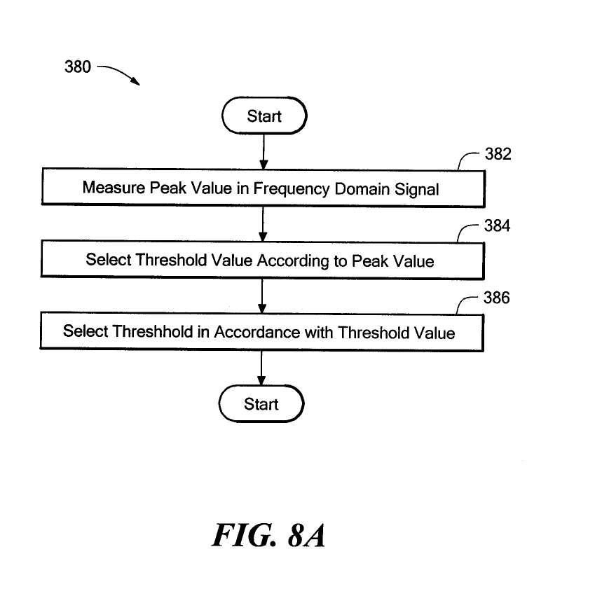

It should be appreciated that FIGS. 7-8B show flowcharts corresponding to the below contemplated technique which would be implemented in SOD radar 14 (FIG. 1). Rectangular elements (typified by element 302 in FIG. 7), herein denoted “processing blocks,” represent computer software instructions or groups of instructions.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the invention. Thus, unless otherwise stated the blocks described below are unordered meaning that, when possible, the steps can be performed in any convenient or desirable order.

Referring now to FIG. 7, a method 300 of radar processing begins at block 302, where a SOD radar, for example, the SOD radar 14 of FIG. 1, transmits an RF signal. In some arrangements, the transmitted RF signal is an FMCW signal having a start frequency and a stop frequency.

At block 304, the SOD radar receives an echo RF signal in response to the transmitted RF signal impinging upon another automobile and echoing back to the SOD radar. At block 306, the SOD radar provides beamforming in receive beams, thereby receiving the echo RF signal in at least one receive beam as a respective beamformed signal.

At block 308, the beamformed signal is processed by the SOD radar to provide a baseband signal. For example, as described in one of more of the above referenced patents and patent applications, the beamformed signal can be combined (e.g., mixed) with a version of the transmitted signal to generate the baseband signal. The echo RF signal received at block 304 is generally above about 20 GHz, and the baseband signal of block 308 is generally below about 200 MHz.

At block 310, the baseband signal, a time domain signal, is converted to a frequency domain signal by way of a discrete Fourier transform, for example, a fast Fourier transform.

At block 312 a threshold is selected for each one of the receive beams generated at block 306. Selection of thresholds is described more fully below in conjunction with FIG. 7A. Taking one receive beam and associated beamformed signal as representative of the other receive beams and respective beamformed signals, at block 314, the frequency domain signal is compared with a respective threshold selected at block 312. In some embodiments, the threshold is essentially flat across the frequency range of the of the frequency domain signal. However, in other embodiments, the threshold has a shape, which is non-flat or which is only piecewise flat across the frequency range of the of the frequency domain signal.

At block 316, a detection value is generated if the comparison performed at block 314 is indicative of an object being within the beam.

Referring now to FIG. 7A, a method 320 can be used to select a threshold as in block 312 of FIG. 7. The term “threshold” is used herein to describe a plurality of threshold values, which can be compared against a frequency domain signal across frequencies. For a flat threshold, the plurality of threshold values can be equal, but nevertheless, the threshold values are used for comparison with a frequency domain signal in different parts of the frequency spectrum of a frequency domain signal. The term “threshold value” is used herein to describe one value of the plurality of threshold values, which together form a threshold.

At block 322, a peak value is identified in the frequency domain signal generated at block 310 of FIG. 7, and which is associated with one receive beam. It will be appreciated that the peak value may be representative of an object being within the receive beam. Peak values can be similarly identified in other ones of the receive beams. In some embodiments, the peak value identified at block 322 is a highest value in the frequency domain signal. In other embodiments, the peak value identified at block 322 is the value of a feature having a peak in the frequency domain signal, and which is indicative of a closest object, i.e., a lowest frequency in the frequency domain signal. In still other embodiments, the peak value identified at block 322 is the value of a feature having a peak in the frequency domain signal, and which is indicative of an object at another range.

Taking the processing of one beam as representative of processing the other beams, at block 324, a threshold value is selected in accordance with the identified peak value in the frequency domain signal associated with the beam being processed. For example, the threshold value can be twenty-five dB below the identified peak value of block 322.

At block 326, a correction value is selected in accordance with a function of angle, wherein the angle is the angle of the beam being processed. The mathematical function can be one of the mathematical functions of FIG. 4A. However, other mathematical functions can also be used.

At block 328, the correction value is combined with the threshold value of block 324 to provide a corrected threshold value and a threshold in accordance with the corrected threshold value. In some embodiments, the correction value is added to the threshold value and in other embodiments, it is subtract. However, other combinations can also be used.

In some arrangements, the threshold has a predetermined shape across the spectrum of a time domain signal, and therefore, having only the one corrected threshold value in the beam being processed can result in identification of a threshold (i.e., a scaling of the threshold having a predetermined shape) across the entire frequency spectrum of the frequency domain signal of block 310 of FIG. 7. However, in other embodiments, the threshold is adaptive, for example, having a shape that adapts in accordance with one or a variety of factors. For these embodiments, having only the one corrected threshold value in the beam being processed can still result in identification of a threshold (i.e., a scaling of the threshold having an otherwise adapted shape) across the entire frequency spectrum of the frequency domain signal of block 310 of FIG. 7. Similarly, thresholds are determined for other ones of the receive beams.

With this arrangement, since the mathematical function of block 326 is a function of angle, the threshold applied to the different beams at block 314 of FIG. 7 can be different according to the mathematical function of angle.

The processes of FIGS. 7 and 7A are directed to a method of establishing thresholds in each one of a plurality of receive beams. Processes of FIGS. 8-8B described below are directed instead to scaling the magnitudes of signals in each one of the beams, which results in a similar effect.

Referring now to FIG. 8, a method 340 of radar processing begins at block 342, where a SOD radar, for example, the SOD radar 14 of FIG. 1, transmits an RF signal. In some arrangements, the transmitted FM signal is an FMCW signal having a start frequency and a stop frequency.

At block 344, the SOD radar receives an echo RF signal in response to the transmitted RF signal impinging upon another automobile and echoing back to the SOD radar. At block 346, the SOD radar provides beamforming in receive beams, thereby receiving the echo RF signal in at least one receive beam as a respective beamformed signal.

At block 348, the beamformed signal is processed by the SOD radar to provide a baseband signal.

At block 350, the baseband signal, a time domain signal, is converted to a frequency domain signal by way of a discrete Fourier transform, for example, a fast Fourier transform.

At block 352, a scaling value is selected in accordance with a mathematical function of angle. The mathematical function can be one of a variety of functions, including, but not limited to, functions described in FIG. 4A. The selected scaling value, being a function of angle, can be different for each beam, since the beams tend to point toward different azimuth angles.

At block 354, the frequency domain signal is magnitude scaled (i.e., amplified up or down) by way of the scaling value across the associated frequency spectrum.

At block 358, a threshold is selected, which spans the frequency spectrum of the frequency domain signal. Selection of the threshold is further described below in conjunction with FIG. 8A. At block 358, the magnitude scaled frequency domain signal is compared with the threshold and at block 360.

At block 360, a detection value is generated if the comparison performed at block 358 is indicative of an object being within the beam.

Referring now to FIG. 8A, a process 380 can be used to select a threshold in block 356 of FIG. 8. The process begins at block 382, where a peak value is identified in the frequency domain signal generated at block 350 of FIG. 8. It will be appreciated that the peak value may be representative of an object being within the receive beam. Peak values are similarly identified in conjunction with other ones of the receive beams. As described above in conjunction with FIG. 7A, in some embodiments, the peak value identified at block 382 is a highest value in the frequency domain signal. In other embodiments the peak value identified at block 382 is the value of a feature having a peak in the frequency domain signal, and which is indicative of a closest object, i.e., a lowest frequency in the frequency domain signal. In still other embodiments, the peak value identified at block 382 is the value of a feature having a peak in the frequency domain signal, and which is indicative of an object at another range.

Taking the processing of one beam as representative of processing the other beams, at block 384, a threshold value is selected in accordance with the identified peak value in the frequency domain signal associated with the beam being processed. For example, the threshold value can be twenty-five dB below the identified peak value of block 382.

At block 386, the threshold value of block 384 is used to generate a threshold in accordance with the threshold value.

In some arrangements, the threshold has a predetermined shape across the spectrum of a frequency domain signal, and therefore, having only the one threshold value in the beam being processed can result in identification of a threshold across the entire frequency spectrum of the frequency domain signal of block 350 of FIG. 8. However, in other embodiments, the threshold is adaptive, for example, having a shape that adapts in accordance with one or a variety of factors. For these embodiments, having only the one corrected threshold value in the beam being processed can still result in identification of a threshold (i.e., a scaling of the threshold having an otherwise adapted shape) across the entire frequency spectrum of the frequency domain signal of block 350 of FIG. 8. Similarly, thresholds are determined for other ones of the receive beams.

It should be appreciated that the threshold determined in FIG. 8A is not related to the mathematical function described, for example, in conjunction with FIG. 4A. Rather than adjusting the thresholds of each beam, the scaling value of block 352 of FIG. 8 is used to scale the frequency spectrum of a frequency domain signal.

While it is described above that the scaling value of block 352 of FIG. 8 is applied to the frequency domain signal at block 354, it should be appreciated that, in other embodiments, the scaling value can be applied instead to the baseband signal of block 348 of FIG. 8, with substantially the same result. In still other embodiments, the scaling value selected at block 352 can be applied to the beamformed signal of block 346 of FIG. 8.

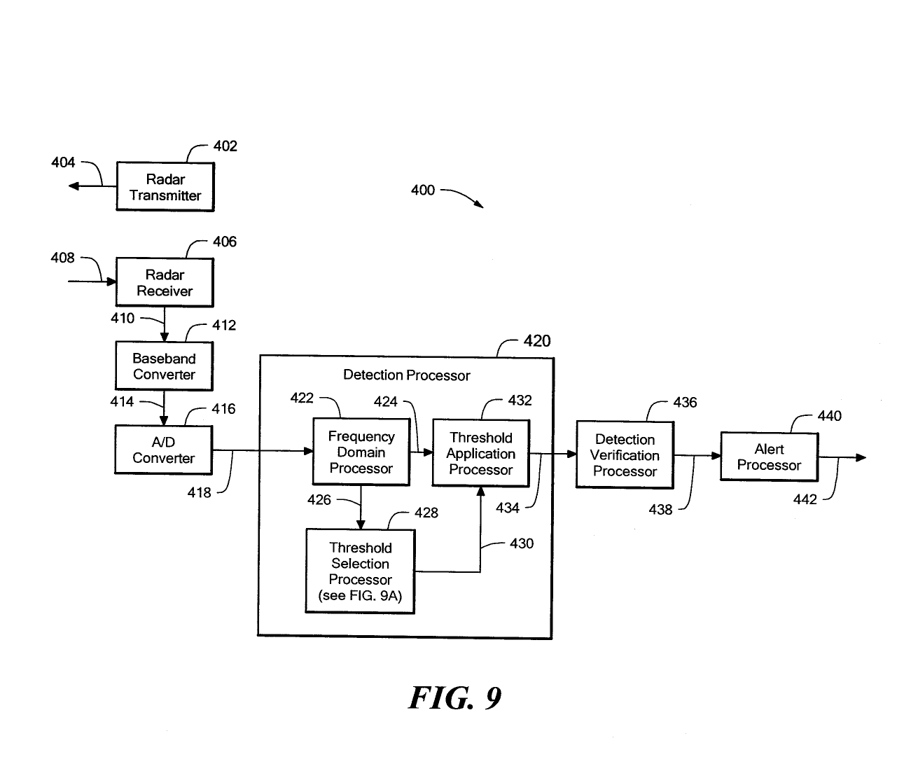

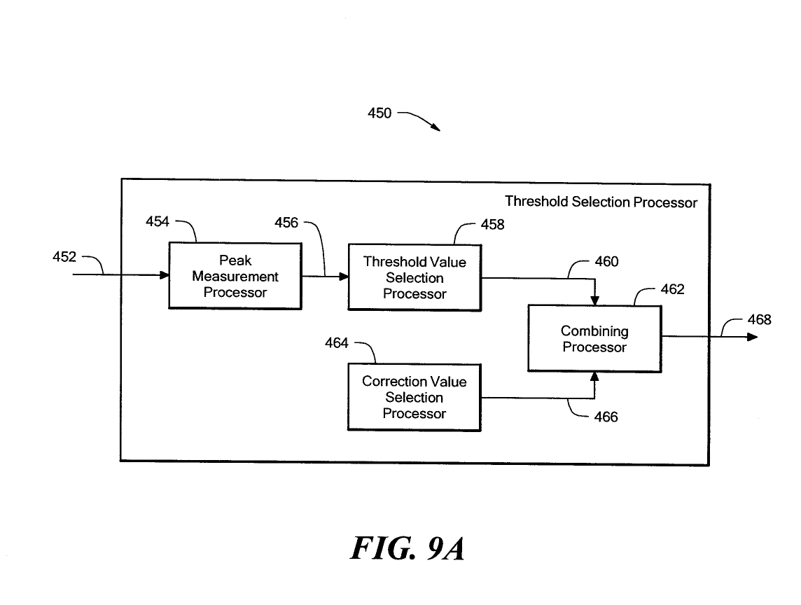

Referring now to FIG. 9, a SOD radar 400 can be the same as or similar to the SOD radar 100 of FIG. 3. The SOD radar 400 includes a radar transmitter 402 adapted to generate chirp RF signals 404. The radar transmitter 402 can be the same as or similar to the transmitter 152 and transmit antenna 154 of FIG. 3. The SOD radar 400 also includes a radar receiver 406 adapted to receive composite signals 408, which can include echo RF signals.

The radar receiver 406 can provide radio frequency (RF) signals 410 to a baseband converter 412. The baseband converter 412 is adapted to convert the RF signals 410 to baseband signals 414, which are provided to an A/D converter 416. The baseband signals 414 are generated by converting the RF signals 410 to a lower frequency. The radar receiver 406 in combination with the baseband converter 412 and the A/D converter 416 can be the same as or similar to the receiver 158 and receive antenna 160 of FIG. 3.

The A/D converter 416 provides digital signals 418 to a detection processor 420. The detection processor 420 can be the same as or similar to the detection processor 104a of FIG. 3. The detection processor 420 is representative of functions that can be performed by the signal processor 104 and/or the control processor 108 of FIG. 3.

The detection processor 420 includes a frequency domain processor 422 adapted to receive the digital signals 418 and to convert the digital signals 418 to frequency domain signals 424, 426. The frequency domain signals 426 are received by a threshold selection processor 428, which generates one or more detection thresholds 430. The frequency domain signals 424 and the detection thresholds 430 are received by a threshold application processor 432. The threshold application processor 432 is adapted to compare the frequency domain signals 424 with the detection thresholds 430 and to provide a detection signal 434 (i.e., a detection table) indicative of the presence or absence of an object in a detection zone (e.g. 24, FIG. 1), also referred to herein as a field of view (FOV), of the SOD radar 400. The detection signal 434 can include detection state values, e.g., true and false values, and can also include detection range values, wherein each true detection state value is associated with a respective detection range value.

An optional detection verification processor 436 is adapted to receive the detection signal 434 and to further process the detection signal 434 in order to apply further criteria to validate or to invalidate a detection of an object. The detection verification processor 436 can generate verified detection signals 438, accordingly, which can include verified detection state values, e.g., verified true and false values, and can also include detection range values. The detection verification processor 436 can be the same as or similar to the detection verification processor 108a of FIG. 3.

An alert processor 440 is adapted to receive the verified detection signals 438 and to generate an alert signal 442, if a detected object falls within a predetermined detection zone (e.g., 24, FIG. 1) and, in some embodiments, if other criteria are met.

Functions of the detection processor 420, the detection verification processor 436, and the alert processor 440 can be performed by the signal processor 104 and/or the control processor 108 of FIG. 3, with any partitioning among the signal processor 104 and control processor 108.

Referring now to FIG. 9A, a threshold selection processor 450 can be the same as or similar to the threshold selection processor 428 of FIG. 9. The threshold selection processor 450 can include a peak measurement processor 454, which, in accordance with the process 320 of FIG. 7A, is adapted to receive a frequency domain signal 452, adapted to identify a peak value in the frequency domain signal 452, and adapted to provide the peak value 456 to a threshold value selection processor 458. The threshold value selection processor 458 is adapted to select a threshold value 460 in accordance with the peak value 456. For example, in some embodiments, the threshold value 460 is selected to be about twenty-five dB below the peak value 456. The peak value 456 is described more fully in conjunction with FIG. 7A.

The threshold selection processor 450 can also include a correction value selection processor 464 adapted to select a correction value in accordance with a mathematical function of angle. The mathematical function of angle can be, but is not limited to, one of the mathematical functions shown in FIG. 4A. The correction value is selected according to an azimuth angle of a receive beam being processed.

The threshold selection processor 450 also includes a combining processor 462 adapted to combine the threshold value 460 and the correction value 466 to generate a threshold 468. To this end, as described above, in some arrangements, the threshold 468 has a predetermined shape across the spectrum of the frequency domain signal 452, and therefore, having only the one threshold value 460 and the one correction value 466 for the beam being processed can result in identification of the threshold 468 across the entire frequency spectrum of the frequency domain signal of block 310 of FIG. 7. In other embodiments, the threshold 468 has an adaptive shape as described more fully in conjunction with FIG. 7A. Similarly, the combining processor 462 is adapted to determine thresholds for other ones of the receive beams.

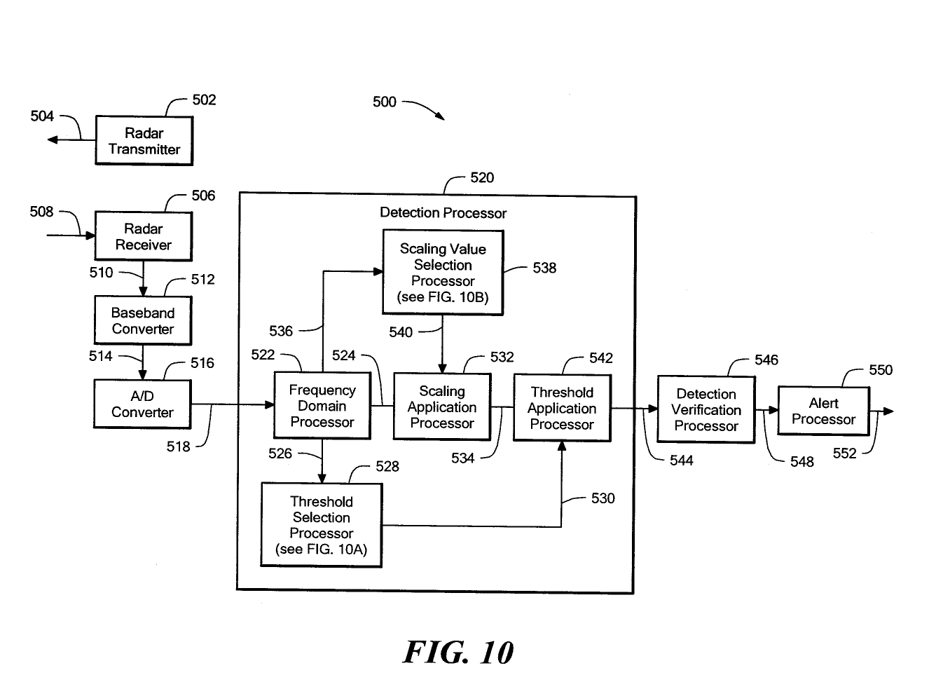

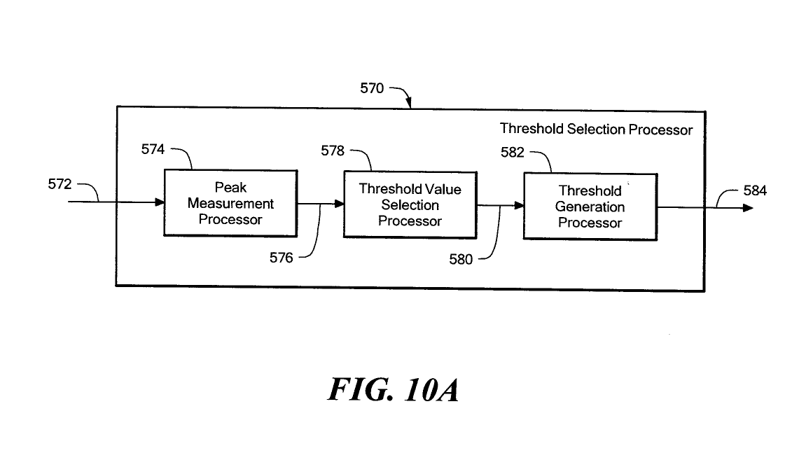

Referring now to FIG. 10, a SOD radar 500 can be the same as or similar to the SOD radar 100 of FIG. 3. The SOD radar 500 includes a radar transmitter 502 adapted to generate chirp RF signals 504. The radar transmitter 502 can be the same as or similar to the transmitter 152 and transmit antenna 154 of FIG. 3. The SOD radar 500 also includes a radar receiver 506 adapted to receive composite signals 508, which can include echo RF signals.

The radar receiver 506 can provide radio frequency (RF) signals 510 to a baseband converter 512. The baseband converter 512 is adapted to convert the RF signals 510 to baseband signals 514, which are provided to an A/D converter 516. The baseband signals 514 are generated by converting the RF signals 510 to a lower frequency. The radar receiver 506 in combination with the baseband converter 512 and the A/D converter 516 can be the same as or similar to the receiver 158 and receive antenna 160 of FIG. 3.

The A/D converter 516 provides digital signals 518 to a detection processor 520. The detection processor 520 can be the same as or similar to the detection processor 104a of FIG. 3. The detection processor 520 is representative of functions that can be performed by the signal processor 104 and/or the control processor 108 of FIG. 3.

The detection processor 520 includes a frequency domain processor 522 adapted to receive the digital signals 518 and to convert the digital signals 518 to frequency domain signals 524, 526, 536. The frequency domain signals 526 are received by a threshold selection processor 528, which generates one or more detection thresholds 530. The threshold selection processor 528 is described more fully blow in conjunction with FIG. 10A.

The frequency domain signals 536 are received by a scaling value selection processor 538 adapted to generate one or more scaling values 540 in accordance with a mathematical function of angle. The mathematical function of angle can be, but is not limited to, one of the mathematical functions of angle of FIG. 4A.

A scaling application processor 532 receives the frequency domain signals 524 and the scaling value 540, according to a particular receive beam being processed, and applies the scaling value 540 to the frequency domain signal 524, to provide a magnitude scaled frequency domain signal 534.

A threshold application processor is adapted to compare the threshold 530 and the magnitude scaled frequency domain signal 534 and to provide a detection signal 544 (i.e., a detection table) indicative of the presence or absence of an object in a detection zone (e.g. 24, FIG. 1), also referred to herein as a field of view (FOV), of the SOD radar 400. The detection signal 544 can include detection state values, e.g., true and false values, and can also include detection range values, wherein each true detection state value is associated with a respective detection range value.

An optional detection verification processor 546 is adapted to receive the detection signal 544 and to further process the detection signal 544 in order to apply further criteria to validate or to invalidate a detection of an object. The detection verification processor 546 can generate verified detection signals 548, accordingly, which can include verified detection state values, e.g., verified true and false values, and can also include detection range values. The detection verification processor 546 can be the same as or similar to the detection verification processor 108a of FIG. 3.

An alert processor 550 is adapted to receive the verified detection signals 548 and to generate an alert signal 552, if a detected object falls within a predetermined detection zone (e.g., 24, FIG. 1) and, in some embodiments, if other criteria are met.

Functions of the detection processor 520, the detection verification processor 546, and the alert processor 550 can be performed by the signal processor 104 and/or the control processor 108 of FIG. 3, with any partitioning among the signal processor 104 and control processor 108.

Referring now to FIG. 10A, a threshold selection processor 570 can be the same as or similar to the threshold selection processor 528 of FIG. 10. The threshold selection processor 570 can include a peak measurement processor 574, which, in accordance with the process 380 of FIG. 8A, is adapted to receive a frequency domain signal 572, adapted to identify a peak value in the frequency domain signal 572, and adapted to provide the peak value 576 to a threshold value selection processor 578. The threshold value selection processor 578 is adapted to select a threshold value 580 in accordance with the peak value 576. For example, in some embodiments, the threshold value 580 is selected to be about twenty-five dB below the peak value 576. The peak value 576 is described more fully in conjunction with FIG. 8A.

The threshold selection processor 570 also includes a threshold generation processor 582 adapted to receive the threshold value 580, and adapted to generate a threshold 594 across the frequency spectrum of the frequency domain signal 572. To this end, as described above, in some arrangements, the threshold 584 has a predetermined shape across the spectrum of the frequency domain signal 572, and therefore, having only the one threshold value 580 for the beam being processed can result in identification of the threshold 584 across the entire frequency spectrum of the frequency domain signal of block 350 of FIG. 8. In other embodiments, the threshold 584 has an adaptive shape as described more fully in conjunction with FIG. 7A. Similarly, the threshold generation processor 582 is adapted to determine thresholds are for other ones of the receive beams.

All references cited herein are hereby incorporated herein by reference in their entirety.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1. A method of radar processing, comprising:
transmitting an RF signal toward a object;
receiving an echo RF signal indicative of the object;
beamforming the echo RF signal to provide a beamformed signal associated with a spatial angle;
processing the beamformed signal to provide a baseband signal;
converting the baseband signal to the frequency domain to provide a frequency domain signal;
selecting a threshold in accordance with the frequency domain signal and in accordance with a mathematical function relating the spatial angle to a magnitude;
comparing the frequency domain signal with the threshold; and
generating a detection value in response to the comparing.

2. The method of claim 1, wherein the mathematical function is a selected one of a cosine function, a cosine squared function, a cosine cubed function, a one plus angle function, a one plus angle squared function, or a one plus angle cubed function.

3. The method of claim 1, wherein the selecting the threshold comprises:
measuring a peak value in the frequency domain signal;
selecting a threshold value, wherein the threshold value is a predetermined amount below the peak value;
selecting a correction value, wherein the correction value is selected in accordance with the mathematical function; and
combining the threshold value with the correction value to provide the threshold.

4. The method of claim 3, wherein the object has a predetermined radar cross section.

5. A method of radar processing, comprising:
transmitting an RF signal toward an object;
receiving an echo RF signal indicative of the object;
beamforming the echo RF signal to provide a beamformed signal associated with a spatial angle;
processing the beamformed signal to provide a baseband signal;
converting the baseband signal to the frequency domain to provide a frequency domain signal;
selecting a scaling value, wherein the scaling value is selected in accordance with a mathematical function relating the spatial angle to a magnitude;
magnitude scaling the frequency domain signal in accordance with the scaling value;
selecting a threshold;
comparing the magnitude scaled frequency domain signal with the threshold; and
generating a detection value in response to the comparing.

6. The method of claim 5, wherein the mathematical function is a selected one of a cosine function, a cosine squared function, a cosine cubed function, a one plus angle function, a one plus angle squared function, or a one plus angle cubed function.

7. The method of claim 5, wherein the object has a predetermined radar cross section.

8. The method of claim 5, wherein the selecting the threshold comprises:
measuring a peak value in the frequency domain signal;
selecting a threshold value, wherein the threshold value is a predetermined amount below the peak value; and
selecting the threshold in accordance with the threshold value.

9. The method of claim 8, wherein the object has a predetermined radar cross section.

10. Radar apparatus, comprising:
a radar transmitter adapted to transmit an RF signal toward an object;
a radar receiver adapted to receive an echo RF signal indicative of the object and adapted to beamform the echo RF signal to provide a beamformed signal associated with a spatial angle;
a baseband converter adapted to process the beamformed signal to provide a baseband signal;
a frequency domain processor adapted to convert the baseband signal to the frequency domain to provide a frequency domain signal;
a threshold selection processor adapted to select a threshold in accordance with the frequency domain signal and in accordance with a mathematical function relating the spatial angle to a magnitude; and
a threshold application processor adapted to compare the frequency domain signal with the threshold, and further adapted to generate a detection value in response to the comparison.

11. The apparatus of claim 10, wherein the mathematical function is a selected one of a cosine function, a cosine squared function, a cosine cubed function, a one plus angle function, a one plus angle squared function, or a one plus angle cubed function.

12. The apparatus of claim 10, wherein the threshold selection processor includes:
a peak measurement processor adapted to measure a peak value in the frequency domain signal;
a threshold value selection processor adapted to select a threshold value, wherein the threshold value is a predetermined amount below the peak value;
a correction value selection processor adapted to select a correction value, wherein the correction value is selected in accordance with the mathematical function; and
a combining processor adapted to combine the threshold value with the correction value to provide the threshold.

13. The apparatus of claim 12, wherein the object has a predetermined radar cross section.

14. Radar apparatus, comprising:
a radar transmitter adapted to transmit an RF signal toward an object;
a radar receiver adapted to receive an echo RF signal indicative of the object and adapted to beamform the echo RF signal to provide a beamformed signal associated with a spatial angle;
a baseband converter adapted to process the beamformed signal to provide a baseband signal;
a frequency domain processor adapted to convert the baseband signal to the frequency domain to provide a frequency domain signal;
a scaling value selection processor adapted to select a scaling value in accordance with a mathematical function relating the spatial angle to a magnitude;
a scaling application processor adapted to magnitude scale the frequency domain signal in accordance with the scaling value;
a threshold selection processor adapted to select a threshold; and
a threshold application processor adapted to compare the magnitude scaled frequency domain signal with the threshold, and further adapted to generate a detection value in response to the comparing.

15. The apparatus of claim 14, wherein the mathematical function is a selected one of a cosine function, a cosine squared function, a cosine cubed function, a one plus angle function, a one plus angle squared function, or a one plus angle cubed function.

16. The apparatus of claim 14, wherein the object has a predetermined radar cross section.

17. The apparatus of claim 14, wherein the threshold selection processor includes:
a peak measurement processor adapted to measure a peak value in the frequency domain signal;
a threshold value selection processor adapted to select a threshold value, wherein the threshold value is a predetermined amount below the peak value; and
a threshold generation processor adapted to select the threshold in accordance with the threshold value.

18. The apparatus of claim 17, wherein the object has a predetermined radar cross section.
